(19) United States
(12) Patent Application Publication
(10) Pub. No.: US 2002/0072968 A1
(43) Pub. Date: Jun. 13, 2002

(54) System and method for incentivizing online sales

(76) Inventors: Richard B. Gorelick, New York, NY (US); David J. Wilson, Austin, TX (US)

Correspondence Address: ROTHWELL, FIGG, ERNST & MANBECK, P.C., 1425 K STREET, N.W., SUITE 800, WASHINGTON, DC, 20005, US

(21) Appl. No.: 09/734,044

(22) Filed: Dec. 12, 2000

(51) Int. Cl. G06F 17/60

(52) U.S. Cl. 705/14; 705/26; 705/27

(57) ABSTRACT

A method for providing monetary incentive to customers that purchase from online vendors through the host. The host accepts and processes a purchase request from the customer to complete a transaction between the customer and the vendor, and the host then gives a financial reward to the customer for placing the purchase request through the host. This reward may be in numerous possible forms such as a discount on the present purchase, a rebate after completion of the present purchase, a free promotional item, a coupon for a discount on future purchases, etc. The host may provide more complex requirements for the financial reward. For example, the host may require the customer to make a minimum number of purchases or to purchase a minimum amount before receiving the financial reward. Similarly, the host may require the customer to refer another user to the host or to otherwise participate in the host before providing the financial reward.

### FIELD OF THE INVENTION

This invention relates to commercial transactions over a distributed network, and more specifically to a system and method for providing a financial incentive that encourages a user to place an online order to a vendor through a third party site.

### BACKGROUND AND RELATED PRIOR ART

Ever increasing numbers of users are connecting to distributed networks such as the Internet, with similarly expanding numbers of businesses following onto the networks to sell goods and services to the online users. However, as more content providers appear on distributed networks, it becomes more and more difficult for users to identify and locate specific desired information available on the network. Even when using search engines (programs that map and catalog information on the distributed networks) users are often unable to locate desired information in a sea of potential sources or, conversely, identify too many potential sources. For instance, a user seeking to purchase a particular product may find numerous reviews, advertisements, comparisons, etc. before actually finding a business offering to sell the desired product. Thus, the efficient organization and distribution of information on the distributed networks have become increasingly important and profitable activities, especially in the field of commercial transactions over the distributed network, otherwise termed “e-commerce.”

Overall, e-commerce is becoming a large and important segment of the economy. In fact, e-commerce has developed to the extent that virtually any good or service is available online, generally from multiple sources. As a result, the task facing a user, hereafter “customer,” seeking to make a purchase online is to differentiate the multiple online businesses, hereafter “vendors,” offering to sell products or services. For example, the customer seeking to purchase a book can choose from scores of vendors. This online environment has made the collection and presentation of information on the existing vendors popular and profitable activities.

In particular, it is well known for an online entity, hereafter called a “host,” to provide a virtual catalog containing product information collected from numerous vendors. In this way, the customer may view the entire inventory from the numerous vendors at one location on the network. A typical display may include images and descriptions of the items, the prices from each of the vendors, and the vendors' sales terms. Consequently, the potential customer may rapidly identify the vendor offering the lowest prices, the vendor having the best return policy, the vendor offering the quickest delivery, etc. The host's display allows the customer to easily compare and differentiate the vendors from each other.

The host may be any entity on a network that is not associated with the customer or the vendor. In particular, the host does not purchase items from the vendor, and the host does not profit from sales by the vendor except for receiving some type of fee or commission from the vendor for referring the customer. Using a common industry term, the host may be “affiliated” with the vendor, as described in U.S. Pat. No. 6,029,141 issued to Bezos, et al. An affiliated site displays product information provided by the vendor and refers the customers to the vendor in exchange for a commission paid by the vendor. The host does not have any control over operation of the vendor's business or the administration of the vendor's inventory.

For example, the assignee of the present invention, Deja.com Inc. has developed a popular online business that collects, stores and presents information from multiple sources, including the Usenet, other sites on the Internet, and postings placed by users. As part of this service, information from the multiple online vendors is collected and made available online.

Hosts have many incentives to provide these information services to customers. Many of the vendors pay commissions to the host in exchange for sales that are tracked as originating from the host. Thus, the host seeks to encourage as many sales as possible. The hosts may also charge service fees to the customers, although this practice is unusual. Furthermore, the host can charge to display advertisements on the host's site. The fees for the online advertisements generally correspond to the number of visitors, with higher numbers of visitors resulting in higher advertising fees. As a result, the host further seeks to attract as many customers as possible.

Overall, hosts are popular with both customers and the vendors. The customers generally like using the host to research and order products because, as described above, the customers can simultaneously research the multiple vendors. Furthermore, the host tends to organize information for easy use by the customers. Because of their popularity with customers, vendors like to provide product information for display by the hosts. In particular, the hosts allow the vendors to easily and effectively reach numerous potential customers.

As result, there are now many hosts seeking to attract the attention of customers. While the vendors attract the customers and encourage sales by providing special discounts, promotions, and other financial incentives, no analogous methods exist for use by the host to attract the customers. As a result, a current need exists for a methodology that allows a host to attract more online customers. More specifically, there is a current need for a method to increase sales that originate through a host.

### SUMMARY OF THE INVENTION

It is therefore an object of the present invention to provide a method to allow a host to attract an increased number of customers, and more particularly, it is a goal of the present invention to provide a method to increase sales that originate through a host site. These goals are accomplished in the present invention by providing a monetary reward to customers that make purchases from online vendors through the host. The method comprises the steps of (1) a host accepting and processing a purchase request from a customer to initiate a transaction between the customer and a vendor, and (2) the host then giving a financial reward to the customer for having placed the purchase request through the host. In the present invention, the host may receive some type of fee or commission for providing the service but is not otherwise associated with the vendor. The reward according to the method may be in numerous possible forms such as a discount on the present purchase, a rebate after completion of the present purchase, a free promotional item, a coupon for a discount on future purchases, etc.

The present invention further provides several alternative embodiments of the above method. In a preferred embodiment, the customer registers with the host before receiving the financial reward. As part of this process, the host collects biographical or demographical information from the customer and stores this information in a data structure such as a database. The host may then identify the customer during future transactions and store in the database a record of the customer's purchases. In this way, the host may provide more complex requirements for the financial reward. For example, the host may require the customer to make a minimum number of purchases or to spend a minimum amount through the host before receiving the financial reward. Similarly, the host may require the customer to refer another user to the host or to otherwise participate in activities such as surveys, etc. sponsored by the host before providing the financial reward.

### BRIEF DESCRIPTION OF THE DRAWINGS

These and other features and advantages of the invention will now be described with reference to the drawings, which refer to like elements with like numbers and in which:

FIG. 1 is a flowchart of a known method for allowing a customer to place an order through a host on a distributed communication network;

FIG. 2 is a flowchart of a method for encouraging online transactions through a host in accordance with an embodiment of the present invention;

FIGS. 3A-3I illustrate contents of a host site displayed to a customer at various stages of the method of the present invention;

FIG. 4 is a flowchart illustrating the process of registering customers in accordance with a preferred embodiment of the present invention;

FIG. 5 is a schematic flow diagram illustrating the administration of the method of FIG. 2 in accordance with an embodiment of the present invention; and

FIG. 6 is a schematic diagram of a system to carry out the method of FIG. 2 in accordance with an embodiment of the present invention.

### DETAILED DESCRIPTION OF THE PREFERRED EMBODIMENTS

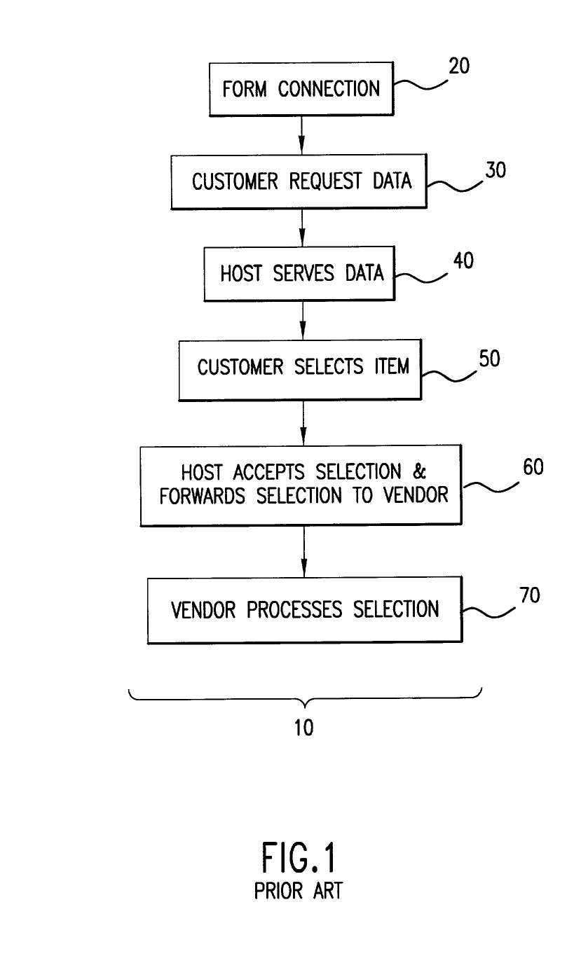

It is generally not difficult to design a host site so that it allows a customer to place an order with a vendor through the host. For example, a known method 10 for allowing the customer to place an order through the host is summarized in FIG. 1. The method begins by establishing a connection between the host and the customer, step 20. Generally, the host resides on a “server” and the customer accesses the host site from a “client.” The Client-Server paradigm is a model of interaction in a distributed communication system in which a program at one site sends a request to a program at another site and waits for a response. The requesting program is called the client, and the program that responds to the request is called the server. In the context of the World Wide Web (discussed below), the client is a “Web browser,” or simply “browser,” which runs on a computer of the user (customer in the present invention). The program which responds to browser requests by serving Web pages is commonly referred to as a “Web server.”

As part of the connection, the host includes a Web site, a computer system that serves informational content over a network using standard protocols. Typically, a site corresponds to a particular Internet domain name, such as “www.Deja.com,” and includes the content associated with a particular organization. As used in the present invention, the term Web site is generally intended to encompass both (i) the hardware/software server components that serve the informational content over the network, and (ii) the “back end” hardware/software components, including any nonstandard or specialized components, that interact with the server components to perform services for users of the Web site.

Once the connection is established in step 20, the host and the customer interact over a distributed network, such as the Internet. The Internet is a collection of interconnected (public and/or private) is networks that are linked together over various communication mediums by a set of standard protocols, such as TCP/IP and HTTP (discussed below), to form a global, distributed network. It should be appreciated that, while the term Internet generally is used to refer to what is now commonly known as the World Wide Web, it also encompasses other forms of data transfer and is intended herein to apply equally to variations that may be made in the future, including changes and additions to existing standard protocols.

One important segment of the Internet is the World Wide Web (“Web”). The Web is used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is Hypertext Transfer Protocol (“HTTP”), and the Web pages are encoded using Hyper-Text Markup Language (“HTML”) or extendible Markup Language (“XML”). However, the terms “Web” and “World Wide Web” are intended to encompass future markup languages and transport protocols that may be used in place of (or in addition to) XML, HTML and HTTP.

HTTP is the standard World Wide Web client-server protocol used for the exchange of information, such as HTML documents and client requests for such documents, between a browser and a Web server. HTTP includes a number of different types of messages which can be sent from the client to the server to request different types of server actions. For example, a “GET” message, which has the format GET:Uniform Resource Locator (“URL”), causes the server to return the document or file located at the specified URL.

HTML is a standard coding convention and set of codes for attaching presentation and linking attributes to informational content within documents. HTML 2.0 is currently the primary standard used for generating Web documents. During a document authoring stage, the HTML codes (referred to as “tags”) are embedded within the informational content of the document.

In particular, after establishing a connection, the customer forwards to the host a request for information, step 30. Using HTTP, this request is usually in the form of getting a document located at a URL. A URL is a unique address which fully specifies the location of a file or other resource on the Internet. The general format of a URL is protocol://machine_address:port/path/filename. The port specification is optional, and if none is entered by the user, the browser defaults to the standard port for the service that is specified as the protocol. For example, if HTTP is specified as the protocol, the browser will use the HTTP default port of 80.

After receiving the request from the customer, the host serves to the customer's computer an electronic catalog, step 40. The catalog files are generally written in HTML, and when the documents are transferred from the host server to the customer client, the codes are interpreted by the browser and used to parse and display the catalog document. In addition to specifying how the Web browser is to display the document, HTML tags can be used to create links to other Web documents or sites (the tags are commonly referred to as “hyperlinks”). A hyperlink is a navigational link from one document to another, or from one portion (or component) of a document to another. Typically, a hyperlink is displayed as a highlighted word or phrase that can be selected by clicking on it using a mouse to jump to the associated document or documented portion. A set of hyperlinks is combined to form a hypertext system which is a computer-based informational system in which documents (and possibly other types of data entities) are linked together via hyperlinks to form a user-navigable web. In general, the catalog display includes hypertext having at least one hyperlink for each displayed product.

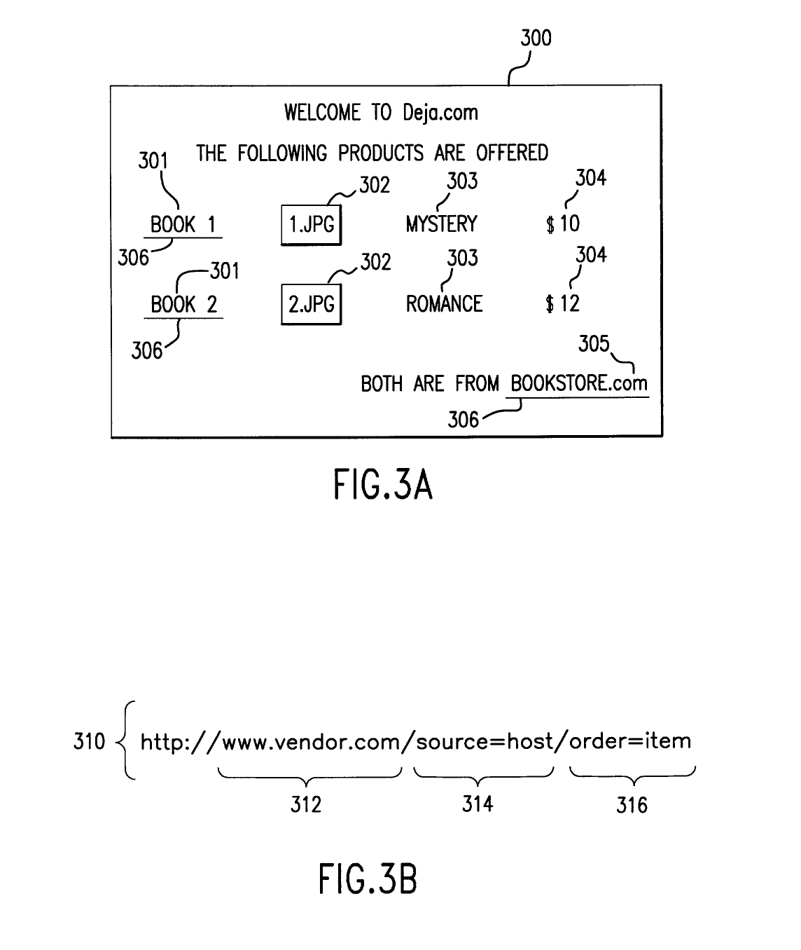

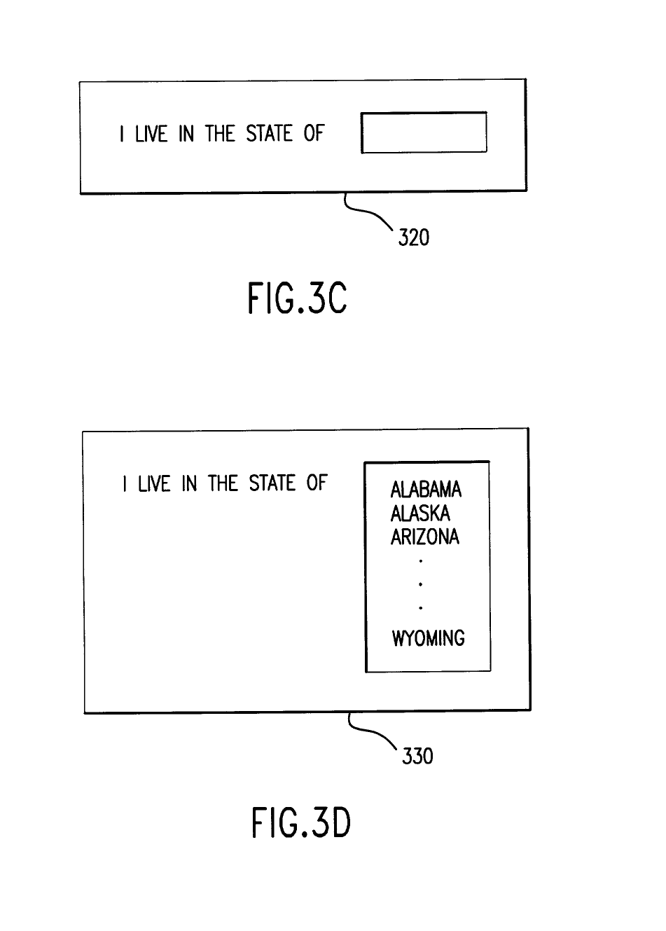

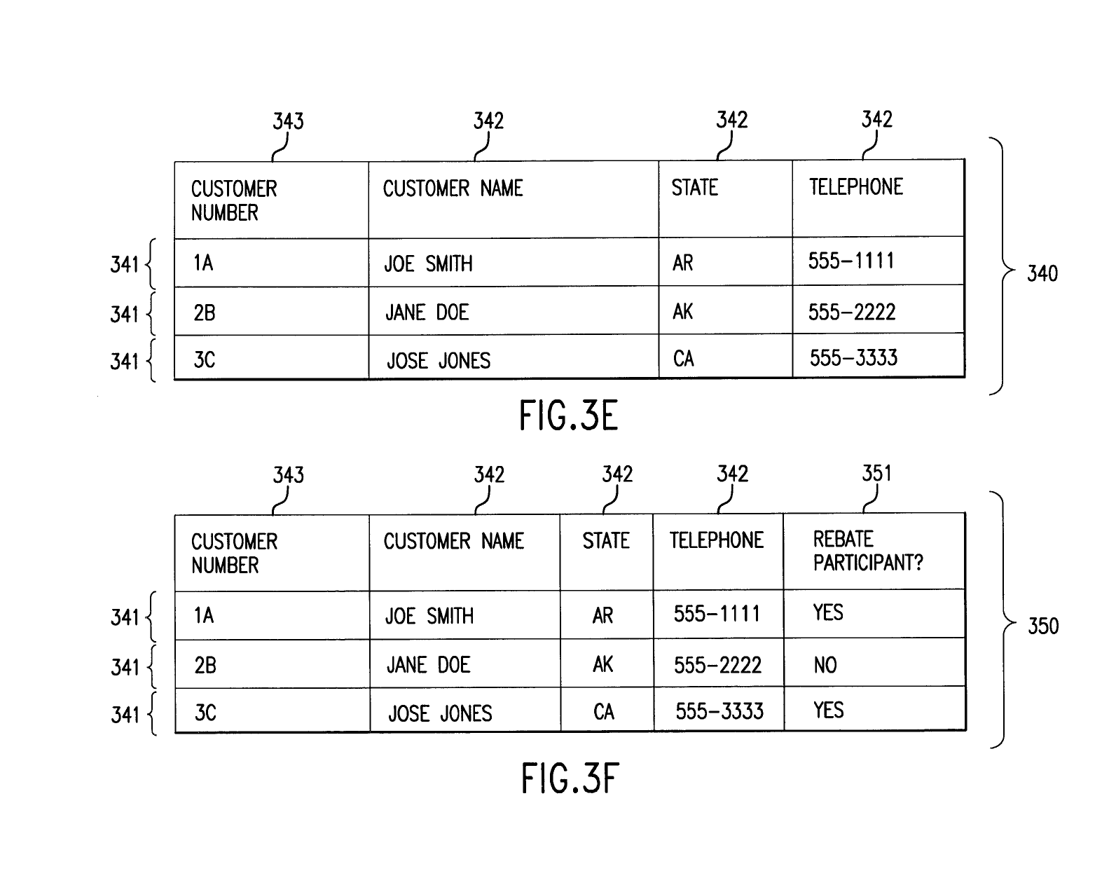

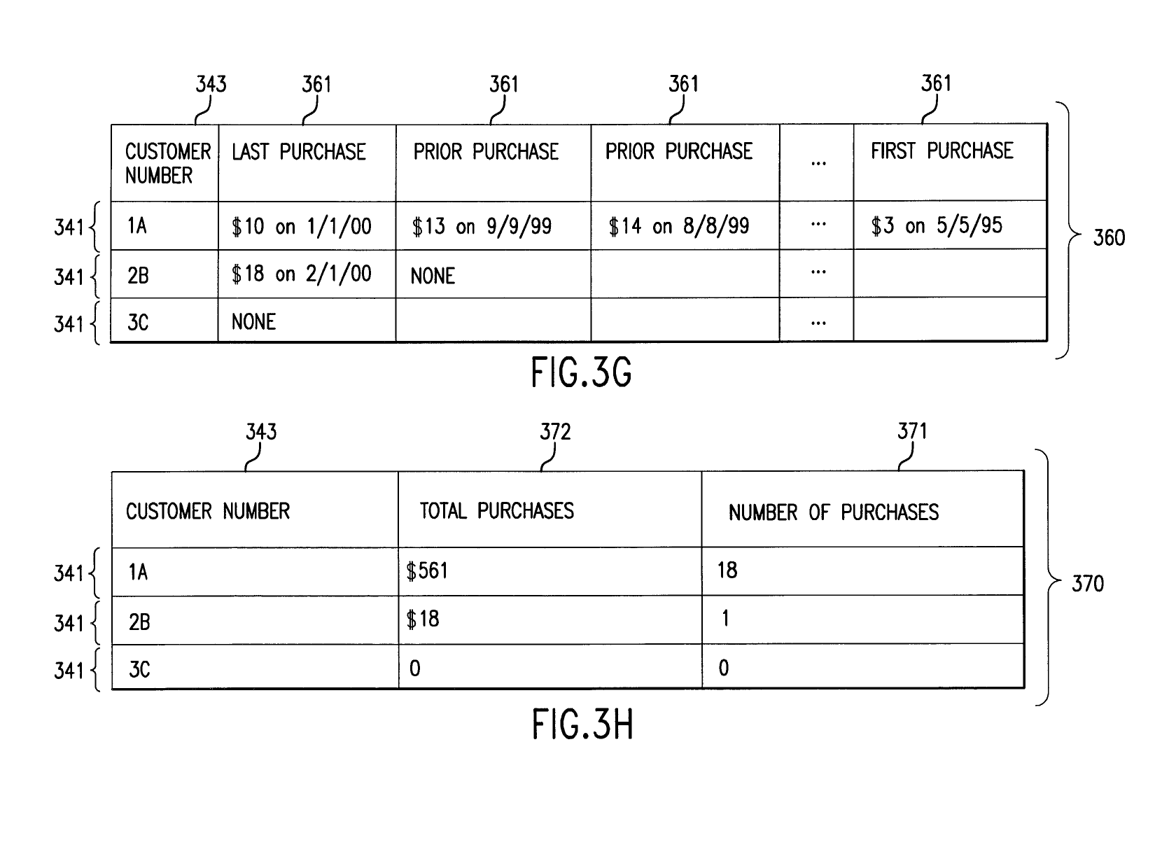

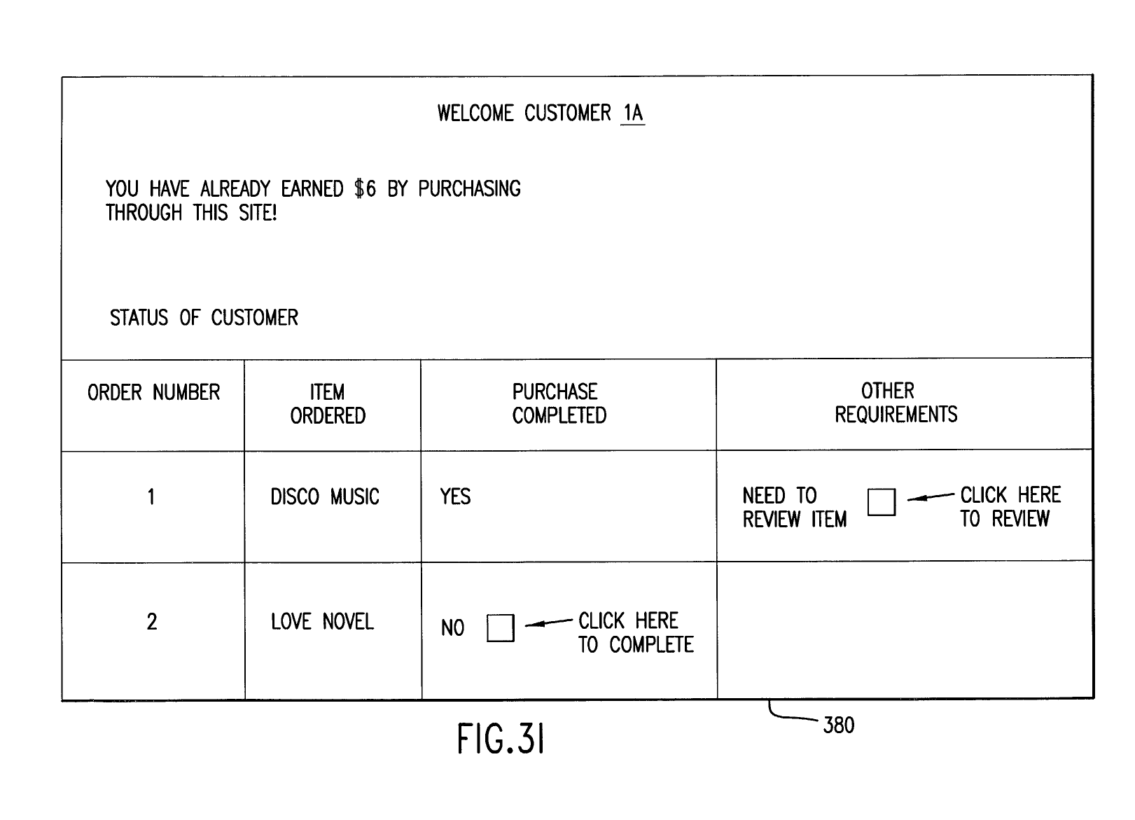

A sample catalog page 300 is illustrated in FIG. 3A. In particular, the illustrated catalog page contains a list of items 301 offered by particular vendors and various information related to the items, such as images 302, descriptions of the items 303, prices 304, and the names of the vendors 305 offering the items. It should be appreciated that many other types of information, such as reviews and ratings of the items, may be provided with the online catalog. The sample catalog page 300 further contains several hyperlinks 306. The hyperlinks are generally visually indicated in the display 300 by a marking, such as underlined text.

The catalog may be formed through various known techniques. Host personnel may manually input the information provided by the vendors. Alternatively, the host may employ “scraper” programs that are designed to automatically seek information over the network to allow the host to automatically collect and update information. In general, scraper programs are very simple and are written to search for a specific piece of information located at a particular location on the network. For example, a scraper may examine a particular location in a vendor's online catalog database. The scrapers may either run intermittently at fixed intervals or in real-time, i.e., in response to a request by the customer.

In step 50, the customer selects an item for purchase by supplying some type of input, such as clicking on a mouse when the cursor is positioned over one of the displayed hyperlinks. For instance, in the page 300 of FIG. 3A, the customer may click on one of the hyperlinks 306 to select a new URL.

The host accepts the input and forwards the input to the vendor, step 60. During step 60, the host serves a web page that allows the customer to place an order with the vendor. For example, in FIG. 3A, selecting a hyperlink 306 at the vendor's name 305 may redirect the customer to the vendor's Web site. Similarly, the customer's selection of a hyperlink 306 one of the items contained in the item list 301 may indicate a desire to purchase the selected item. Typically, the host connects the customer to the vendor to complete the transaction.

As part of step 60, the host sends to the vendor a set of codes that indicates the product selected by the customer and the identity of the host. In this way, the vendor may easily process the customer's purchase request and credit the host for the sale of the particular item. An example of a referral URL 310 is illustrated in FIG. 3B. The referral URL 310 contains the address for the vendor 312, an identifier 314 for the host, and an identifier 316 for the selected product.

Then in step 70, the vendor processes the purchase request. Generally, the vendor places the selected item into a virtual shopping cart and completes the order by collecting payment and shipping information from the customer. It should be noted that the host does not have a role in the transaction once the customer is referred to the host. In this way, the host may easily refer more of the customers to the vendor without incurring increased burdens on processing capability.

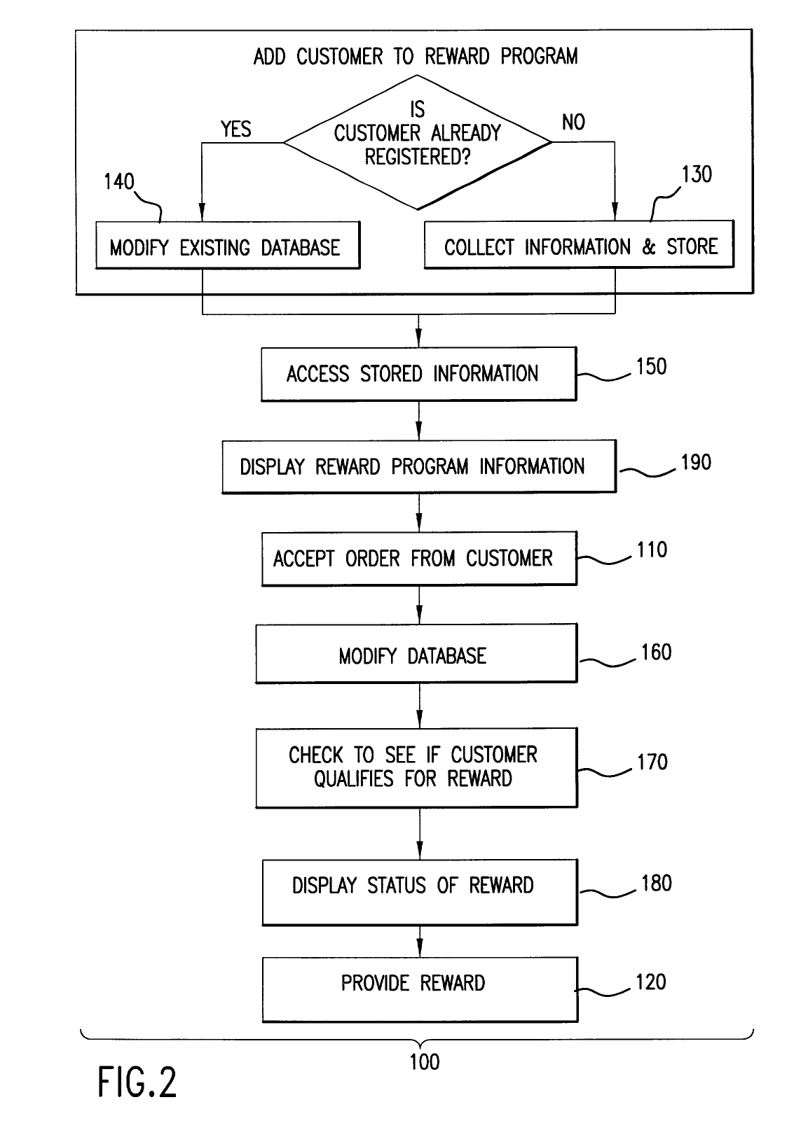

As illustrated in FIG. 2, the present invention provides a method 100 for financially rewarding a customer placing an order through the host. The host accepts a purchase request from the customer and transfers the request to the vendor, step 110. Then, the host pays the customer a financial reward in a predetermined amount, step 120.

Step 110 of the present invention may be accomplished by using the above-described method 10, in which the host presents a hypertext catalog and accept the customer's selection of any of the hyperlinks. While method 10 is provided to demonstrate a known method for the host to refer the customer to the vendor, it should be appreciated that many departures from this method are known and may be used in the present application. Various steps in the method may be skipped as long as the host continues to serve as an intermediary that receives and forwards the customer's request to the vendor. For example, the host may receive via E-mail a purchase request from the customer and then forward the request to the vendor.

A fundamental aspect of the present invention is step 120, in which the host, and not the vendor, pays the customer the financial reward for making a purchase. The nature of the financial reward may vary as determined by the host. For instance, the reward may be a discount on the present purchase in which the host pays for part of the cost of the purchase from the vendor. Discounts are popular with the customers because it provides an immediate benefit to using the host. In a preferred embodiment, the reward is a rebate. The customer receiving the rebate must first pay the full price for the item and, then, later receives a financial compensation from the host. Rebates are easier for the host to administer because the host pays the customer instead of the vendors and because the delay provides an opportunity for the host to process the reward. In another embodiment, the host may provide the customer some type of credit toward future purchases through the host. This type of reward encourages the customer to return to the host to make more purchases. The host may optimally use a combination of these types of financial rewards, such as offering an instant discount, a rebate after the purchase, and a discount on future purchases.

Similarly, the amount of reward may be computed using various different methods. In one embodiment, the reward is a fixed amount for each purchase, such as, for example, one dollar per purchase. This type of reward encourages the customer to make multiple purchases through the host because an increased number of purchases results in larger rewards. Alternatively, the financial reward may be calculated as a percentage of the amount spent by the customer for the purchase. For example, the host may refund the customer 3 percent of the amount spent on purchases placed through the host. This type of reward encourages the customer to make larger purchases through the host because the larger purchases result in larger financial rewards from the host.

In another embodiment, the host receives some type of commission from the vendor for referring the customer, and the financial reward is computed as a portion of the commission. In effect, the host shares with the customer the earnings from the transaction. This embodiment allows the host to prevent losses from payments made to reward customers. In particular, the total amount of financial payments to customers is limited by the commissions paid by the vendors. The host may then recover the lost commissions through alternative sources such as increased advertising rates from the increased numbers of customers.

In another embodiment, the financial reward of step 120 is in the form of goods from certain vendors. In this way, the host may specially promote certain items or vendors. This feature allows the host to better market items to the customer and to better service the needs of the vendor. For example, the vendor may have an excess inventory of a particular item and may wish to discount this item to promote its sale. The vendor may be limited in its ability to discount the item (for example, distribution agreements require the vendors to charge at least a minimum price for the item), so the vendor could coordinate with the host to offer an equivalent, indirect discount.

Alternatively, the host may selectively limit the financial incentive to certain items or classes of items. For example, in a preferred embodiment of the present invention, the financial reward of step 120 is given to the customers that purchase arts and entertainment related items, such as books and recordings of movies and music. The online customer that buys arts and entertainment related items tends to repeatedly purchase these items because of the relatively low cost, the large number of available titles, and the constant introductions of new titles. If the host can attract the customers of these goods, these customers may repeatedly use the host in the future. The host may also promote other products to the customer when she is purchasing an arts and entertainment item. In contrast, a customer buying a large item, such as a car, will tend to make only a single purchase and may never return to the host.

Furthermore, the typical customer that purchases arts and entertainment products falls into a very desirable demographic group. The customer tends to be relatively young, affluent, well-educated and knowledgeable on computers. This type of customer is more likely to return to the host for future purchases. Furthermore, advertisers want to reach this demographic group and pay more to advertise on the host that effectively reaches these customers.

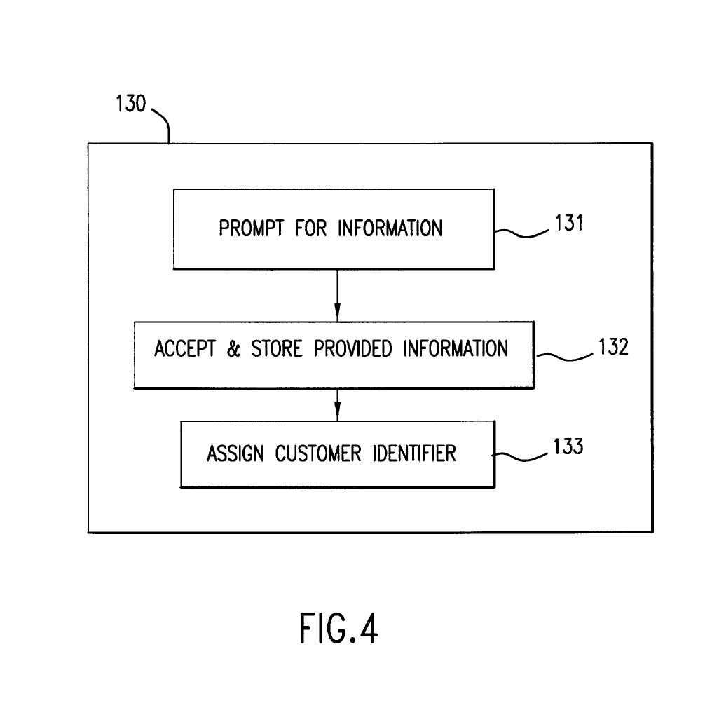

In a preferred embodiment, the customer registers with the host, optional step 130, before receiving the financial reward. Consumers may be required to register to join the host's reward program, thus increasing the size of the host's registered user database. The registration process is summarized in FIG. 4. In particular, the host prompts the customer to provide personal information such as the customer's name and address, step 131. For example, the host may provide input fields as seen in display 320 in FIG. 3C or drop-down menus as seen in display 330 in FIG. 3D. The personal information is then placed into a customer information database, step 132. For example, FIG. 3E illustrates an exemplary customer database 340 that contains a row 341 for each registered customer and each column 342 contains a different type of information on the customers. The illustrated customer database 340 contains columns 342 for the customer's name, state, age, and telephone number.

As part of the customer registration process, the host may assign an identifier to the customer, step 133. The identifier is generally an alphanumeric combination. In FIG. 3E, the customer database 340 contains a column containing the customer identifier 343. The identifier may be associated with the customer's stored biographical information so that this information maybe accessed after when the customer provides the customer identifier. In this way, the customer does not need to repeatedly provide the same information. The host may determine the customer's identifier by requiring the customer to provide the identifier when the customer accesses the host site. For example, it is common to require the submission of a password or code before allowing the customer to view the contents of the host site. Alternatively, the customer's identifier may be stored as a cookie on the customer's computer. Cookies are a technology that enables a Web server to retrieve information from a user's computer that reveals prior browsing activities of the user. The informational item file stored on the user's computer, typically on the hard drive, is commonly referred to as a cookie.

In an alternate embodiment, the host has already collected personal information from the customer and has placed this collected information into an existing database, similar to database 340 in FIG. 3E. For instance, many hosts keep lists of registered customers from prior purchases. The host then needs to differentiate between the customers who wish to receive the financial rewards from the customers that do not wish to participate in a program to provide the financial rewards. This differentiation may be accomplished by modifying the preexisting database, step 140, such as by adding a column to the database that contains an indication of whether the customer is participating in the financial reward program. For example, FIG. 3F illustrates a modified customer database 350 containing a participation column 351. The host may then program its site to check the database whenever a customer makes a purchase to determine if the customer is participating in the financial reward program, step 150. The host pays the financial reward only if the customer is participating in the program. Similarly, the host may be designed to solicit the customer's participation in the financial reward program if the customer is not already participating. For example, the site may display an icon in which the customer may mouse click to join the reward program. The displayed icon generally includes accompanying text such as “Click here to save on all purchases.”

The host may also employ several different financial reward programs. For example, different customers may qualify for different payments based upon past purchases. The host may then design the program to reward the certain customers, such as long-term or frequent customers, with greater payments. To keep track of the different financial rewards programs, the host forms a database that indicates whether the customer is participating in one of the programs and specifying the programs in which the customer is participating. For example, the database 350 of FIG. 3F may be further modified to include a column (not illustrated) that contains an indication of the purchase reward program in which the customer is participating.

In another embodiment of the present invention, the host stores a record of the customer's purchases, step 160. The host may record each of the customer's purchases. For example, FIG. 3G illustrates a purchase record database 360 that stores a record 341 of each purchase. With each purchase, another column 361 is added to the database 360 to form a record 341 of the new purchase. However, this database 360 may rapidly grow too large and unwieldy for practical use. Thus, the host may alternatively store only certain aspects of the customer's purchasing history. For example, FIG. 3H illustrates a database 370 that contains a record of the total number of purchases 371 and a sum of the amounts of purchases 372. These records are running tallies that are adjusted with each purchase by the customer without adjusting the size of the database 370.

By storing the customer's purchasing history, the host may use more complex requirements for the financial reward, step 120. For example, the host may require the customer to make a minimum number of purchases or to spend a minimum amount through the host before receiving the financial reward. As already seen in FIG. 3H, the host may readily store and access this type of information. To implement a more complex reward scheme, the host may intermittently check the customer database to determine which of the customers was qualified for the financial reward, step 170. For example, using a program written in a standard programming language for searching a database, such as standard query language (SQL), the host may search the customer database to identify the customers that have satisfied the conditions for the rebate.

Similarly, as part of step 170, the host may require the customer to make a purchase and to take an additional action. For example, the customer may be required to refer another customer to the host or to otherwise participate in activities conducted by the host before providing the financial reward. For example, the assignee of the present application, Deja.com Inc., administers a Web site that allows customers to review products and could require the customer to complete a review of the purchased product before the host will pay the financial reward. In this way, the host can increase the customer's use of the host's site even when the customer is not placing purchases. The customer may grow accustomed to the host's site and may tend use it even when not purchasing online.

The host site also may form a display that shows the customer's status in the rewards program, step 180. As shown in FIG. 3I, the status display 380 may include various elements such as the names of products ordered by the customer, an indicator of whether the customer has completed the purchase of the product, and an indicator of whether the customer has fulfilled any additional actions required to receive the financial reward, such as whether the product has been rated and reviewed by the customer. This display is generally generated as follows: 1) the host checks a log of items ordered by the customer and lists all the items for which the customer has not yet been rewarded; 2) the host determines and displays whether the customer has completed the transaction(s) for the ordered items; and 3) the host checks the user registration database to determine if the user has completed other requirements for receiving the financial reward. In a preferred embodiment, if the customer has completed the purchase but has not yet completed the other requirements for receiving the financial reward, the host displays a reminder message to the customer indicating the remaining requirements to be satisfied before payment of the financial reward. Optimally, the message may further contain a link that launches an application to allow the user to complete the requirements for the financial reward. For example, if the host requires the customer to complete a review of the purchased product before receiving the financial reward, the host may display a box that allows the customer to draft a review. In a preferred implementation, the host further displays a running total of how much rebate money the member has collected, e.g., “You've earned $6 by purchasing through this site,” as part of the status display.

In another implementation, the host further displays an information page to explain the reward program to the customer, step 190. The information page many include a set of simple text and images that explain how to register and participate in the program. The information page may further indicate which of the customers are eligible to participate in the reward program. Similarly, the information page may indicate the items for which the customers may earn a rebate and the additional requirements that the customer must satisfy before being eligible to receive the reward. The information page may also display a listing of legal terms and conditions as well as a page of frequently asked questions (FAQs).

Overall, the present invention allows the host to effectively reach new customers and encourages the existing customers to make greater use of the host site. The host can effectively market its site by advertising customers' potential savings on purchases from favorite vendors merely by placing orders through the host site. The host therefore offers the customer much financial benefit without requiring significant additional burdens to the customer. The customers thus perceive the host site very positively as a place to find good values and to shop smart. Overall, by creating word of mouth, increasing advertisement conversions, and bringing consumers back more frequently, the host increases the reach of the host site.

While the concept of the present invention may be quite simple, the administration of the present invention may be quite complex. In particular, the host needs to ensure that the customer is adequately rewarded while preventing abuse of the reward program. For example, the host needs to verify that the customer completes the purchase with the vendor. Otherwise, the customer may initiate and subsequently cancel a purchase, but still receive a financial reward.

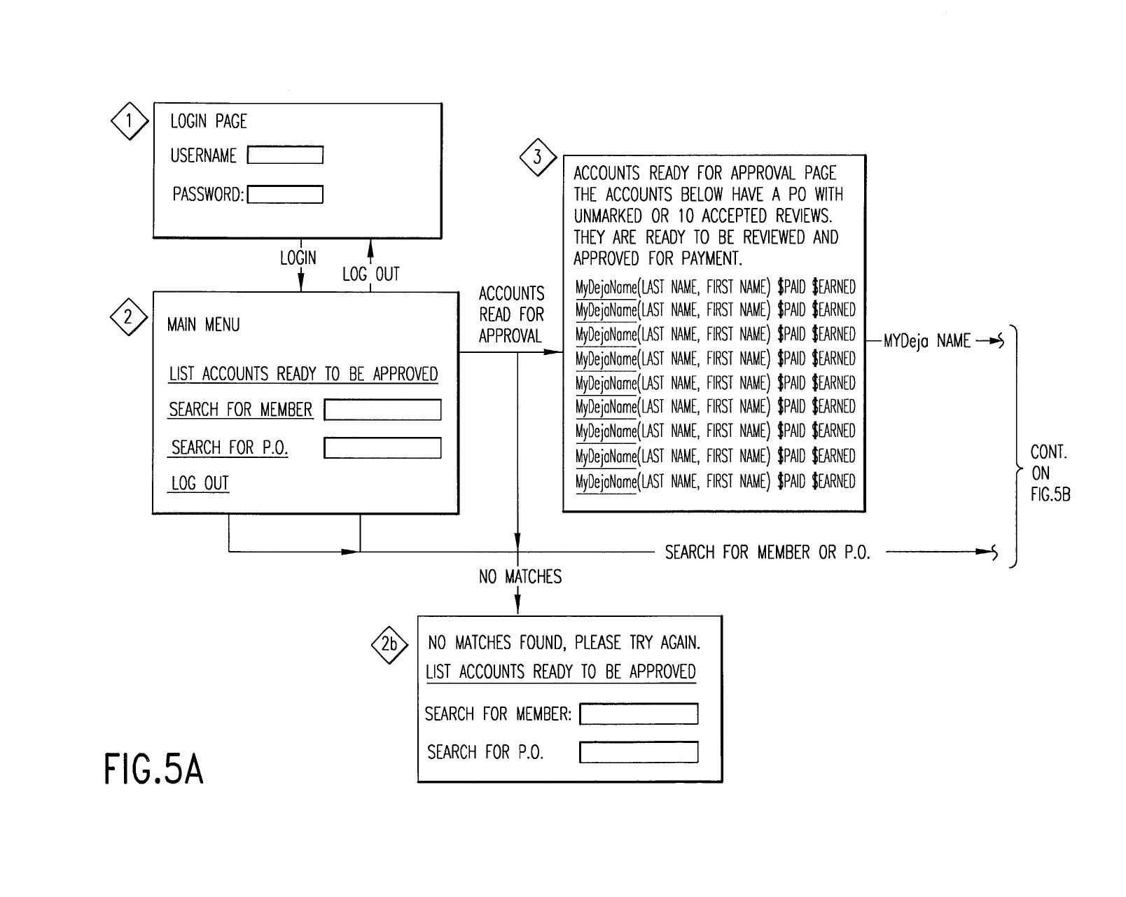

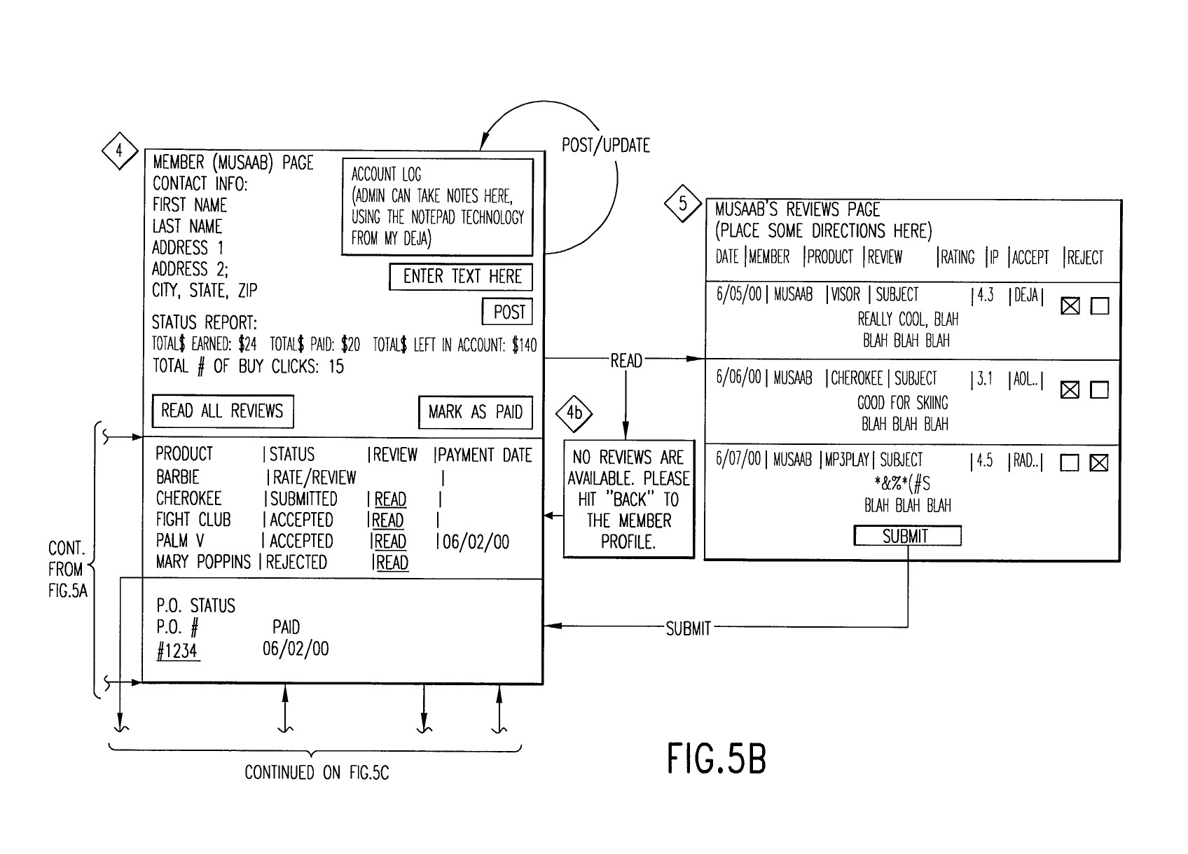

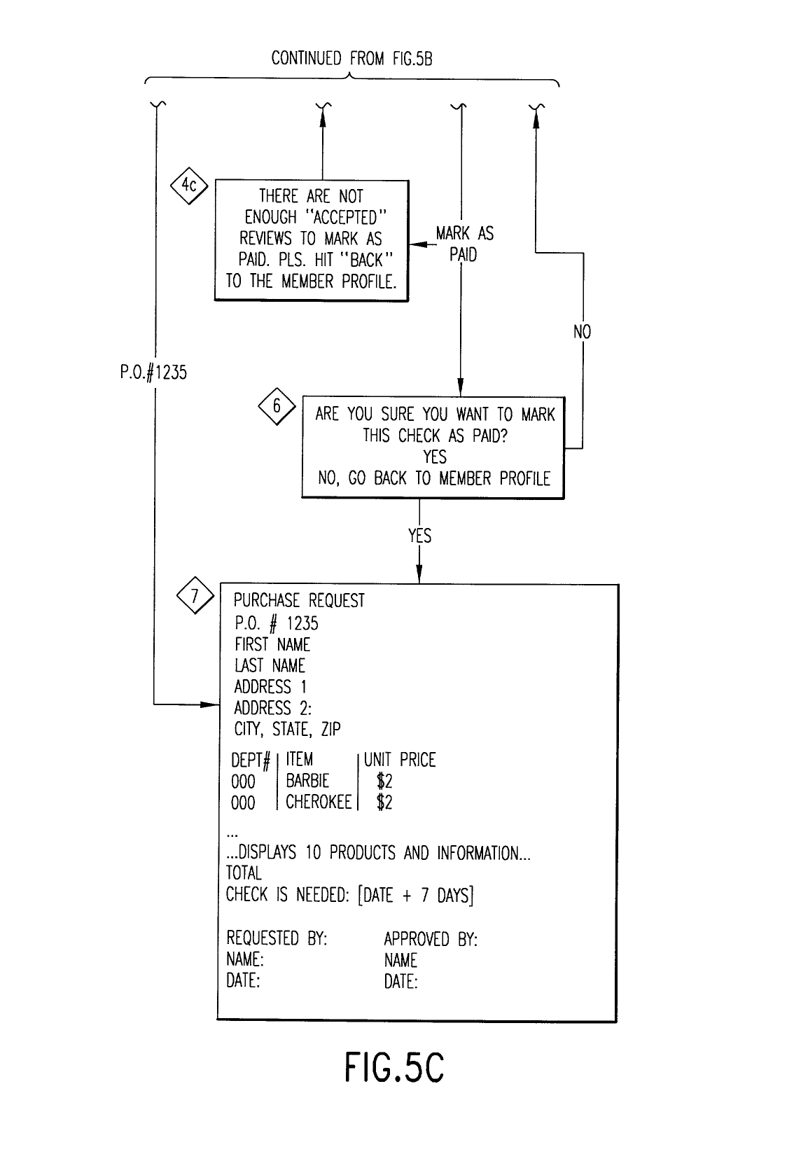

In one embodiment, the host employs an administrative program for administering the financial reward. An overview of the method employed by the administrative program is illustrated in FIG. 5. In the illustrated embodiment, the customer becomes eligible for a payment after making a purchase and posting a review onto the host's site. However, it should be appreciated that any conditions for the reward may be employed by the host with little changes to the administrative tool. In step 1, an employee of the host, hereafter referred to as an “administrator,” logs onto the administrative tool. In order to prevent abuse by the customers, the login is limited to only the personnel of the host. In step 2, the administrator is provided a main menu. The main menu contains the following options: (1) list accounts ready to be approved; (2) search for customer; (3) search for a particular payment out, or “PO,” to the customer; and (4) log off. If the administrator selects “list accounts ready to be approved,” the administrative program queries the database to produce a list of accounts that have satisfied the conditions for receiving the financial reward, which in the illustrated example is to post ten accepted reviews. If the administrator selects “search for customer” and enters the customer's account name, the administrative tool queries the database and displays a profile of that customer. The customer's profile is discussed in greater detail below. Likewise, when the administrator selects “Search for PO” and enters a PO number, the administrative tool queries the customer database and displays the customer profile page to which that PO is assigned. For example, the administrator can search to find out when or to whom a certain payment was made. If the query for the customer or PO finds no matches, the administrator is prompted to specify a different customer or PO, step 2B. An administrator that selects to “Log off” is immediately logged off the administrative tool and returns to the log-in page of step 1. Note that the administrator has the option of performing any of the functions on the main menu at any time during the method and at any page displayed by the administrative tool.

Following the display of the main menu, the administrative tool provides a list of the customers that have qualified for the financial reward, step 3, otherwise titled “Accounts Ready for Approval.” In the illustrated example, the list provides accounts that have made purchases and posted accepted reviews. Again, the method, although discussed in the context of requiring the customer to place a review of the purchased item, may be adapted to enforce any requirements desired by the host. Each account listing may include the following information: the customer identifier (shown as the “My Deja” name); the first and last name that the customer entered during the registration process; “$ Paid,” the total amount of money that has already been “Marked as Paid” to date; and “$ Earned,” the total amount of money earned to date, including any money that has already been “marked as paid.” The difference between the amount earned and the amount paid is owed to the customer.

In step 4, the administrative tool displays the customer profile that summarizes all information associated with the customer's account history. The profile is also the page where the administrator can approve a payment to the customer. The customer profile includes information such as the customer identifier and the customer's names and address, as provided during registration. The customer profile further includes an account log that contains three fields: the log, which is a text box in which the administrator can scroll to read any account activity notes; a text input field for entering new notes; and a “post” button that allows the administrator to update the notes within the text box. The customer profile further displays “total $ earned,” a record of the total amount of money earned by the customer to date, including any money that has already been “marked as paid.” The customer profile also displays “Total $ paid,” the total amount of money that has already been “Marked as Paid” to date. The “Total $ left in account” is also indicated by the customer profile. This amount is found by taking an individual cap (in this case $160) minus the total amount paid. The individual caps limit the amount that can be paid to one customer and helps the administrator identify any fraud or abuse of the reward program.

The customer profile also displays to the administrator the number of purchase orders placed by the customer. For example, the number of purchases in “total # of Buy It Clicks” in FIG. 5 is the accumulated number of purchase inputs the customer has provided since joining the financial reward program. The customer profile also allows the administrator to view the customer's performance of conditions required for the financial reward. In the illustrated example, the administrator may “Read All Reviews” to view a list of all reviews that the customer has submitted. The “Product list” of the customer profile contains all products that the customer has purchased. The columns include the product name, the status of reviews provided by the customer (rate/review, submitted, accepted, rejected), a “read” placeholder link that takes the administrator to the customer's reviews, and the date that financial reward for the purchase was marked as paid. The “PO Status” in the customer profile displays two columns that show a P0 number linked to a PO page and the date that the specified PO was paid. The customer profile allows the administrator to designate that an amount owed to the customer has been satisfied by selecting “Mark as Paid.” In particular, where the customer has satisfied the conditions to receive a financial reward, the administrator selects the “Mark as Paid” button and goes to the PO Request form.

When the administrator seeks to review the customer's performance of required conditions, such as to read the customer's product reviews, but the customer has not yet performed, the administrative tool displays a page showing that the customer has failed to complete the required actions, step 4B. In the example of FIG. 5, a “no reviews” page is displayed.

When the administrator seeks to pay the customer, but the customer has not yet satisfied the conditions for receiving a payment, the administrative tool will display an error message, step 4C. In the illustrated example, the message “P.O. Assignment not allowed” is displayed when the administrator clicks “Mark as Paid,” but the customer has not yet performed the necessary requirements.

In step 5, the administrator can evaluate the customer's performance of the required conditions. If the customer has adequately performed (for example, providing a product review of sufficient length) the purchase is “Marked as Paid” and removed from the customer profile. The record of the customer's performance is recorded under a PO status page. For example, if the customer provides a product review, the PO status page may store the following information: the date the review was submitted; the customer identifier, the name of the product purchased by the user, the text of the review and any rating submitted by the customer, an IP address for the customer, and “accept” and “reject” check-boxes. The administrator may evaluate the customer's review to determine if the customer has performed adequately to receive the financial reward. If the administrator selects “accept,” the customer's account automatically updates the review status. If the administrator rejects the review, the review and product info will disappear from the user's personal page. In a preferred embodiment, the administrator sends a message to the customer that explains why the review was rejected and why the financial reward will not be given. In step 5, after the administrator makes changes to the customer profile, the administrator can select “submit” to update the information. The administrative tool returns to step 4 and redisplays the customer profile page as updated to reflect the changes made by the administrator in step 5.

In step 6, the administrative tool asks the administrator to confirm the payment to the customer. A “Mark as Paid Confirmation” page is displayed, and the administrative tool asks the administrator to verify the payment to the customer. If the administrator selects “Yes,” a payment is made to the customer and a PO number is assigned to the payment. If the administrator selects “No,” the administrative tool returns to step 4 and the customer profile reappears.

Then in step 7, a record for the payment to the customer is formed. The record contains information for the payment to the customer, such as the costumer's name and address, the name of the product selected by the customer, the unit price for the selected product, the total amount of the purchase, and due date for payment to the customer.

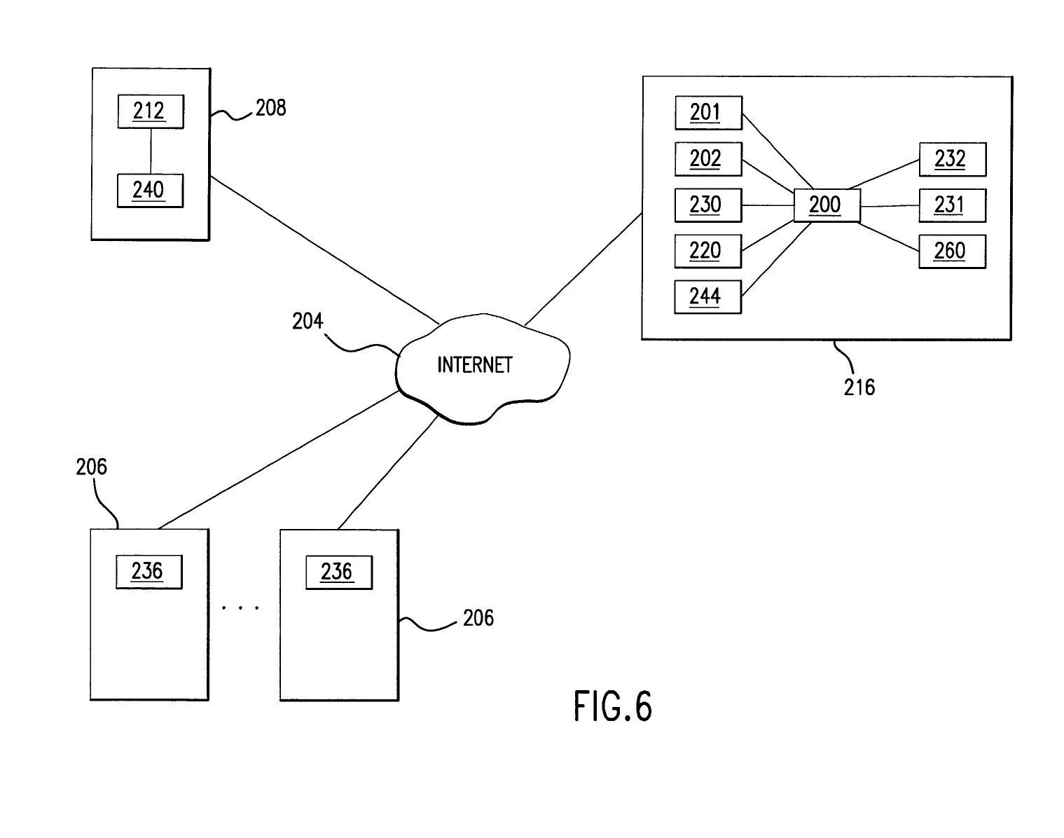

To implement the above-described methodologies, FIG. 6 illustrates the general design of a computer system that operates in accordance with the present invention. The system includes a customer computer 208, a host site 201 on a server 216, and at least one vendor site 206, all of which are linked together by the Internet 204. The customer computer 208 may be any type of computing device that allows the customer to interactively browse Web sites via a Web browser 212. For example, the customer computer 208 may be a personal computer (PC) that runs the Windows operating system marketed by Microsoft Corp.

The vendor site 206 provides various functionalities for allowing customers to purchase products. Typically, this site will be operated by a business entity (the vendor) that handles the various order processing, shipping, collections, and customer service tasks associated with the sale of goods.

The host Web site 201 is the site of an entity that collects and stores product information from the vendors. The host organizes this product information and provides the information for access by the customer. As previously described, the host may be compensated for these services by commissions paid by the vendors or other revenue sources such as the sale of advertising space on the site. Typically, this site is owned and operated by an individual or business entity that is not in the same business as that of the vendors. For example, the assignee of the present invention, Deja.com Inc., specializes in the collection and dissemination of information but does not produce or directly sell any goods.

The host site 201 includes registration software 202 that implements an online registration process for allowing customers (individuals, companies, etc.) to register to receive product rebates. An entity registering as the customer provides the host Web site 201 with biographical information that is processed by a registration software program 202 at the host site 201. The registration software creates an entry in a customer database 260 at the host according to the information provided by the registering customer.

Because the vendor generally handles the tasks of processing on-line orders, shipping products, collecting payment, and providing customer service, the host need not be concerned with these tasks. Thus, the host can concentrate on the presentation of information.

In addition, because the host Web site 201 includes an administration software 230 for automating the payments to the customers, such as the administrative tool described above in FIG. 5, the system allows the host to accept a large number of orders and to reward the customers for these orders with minimal human involvement by personnel at the host. The administration software 230 may include a reward abuse identification program 231. The reward abuse identification program 231 is a reporting script that examines the reward data for each customer and identifies costumers who have received numerous rewards (such as more than 10 payments in total) or who has been paid frequently on a short time period (such as twice within a one-month period). The reward abuse identification program 231 may also create an index of all customers who have ever been paid and report when multiple registered customers have the same zip code, street number, and first word of the street name. For example, if one customer lives at 7717 Baja Cove, Austin, Tex. 78759 and another customer lives at 7717 Baja St., Austin, Tex. 78759, then the reward abuse identification program 231 specifies these customers as a match. This process identifies people who set up multiple customer accounts with identical or similar addresses when trying to defraud the reward program system.

The host may further display an information page 232 to describe the financial reward program, thus reducing the need of the personnel of the host to directly interact with customers to explain the requirements for the reward.

In operation, the customer accesses the host Web site 201 using a standard Web browser 212, such as Microsoft's Internet Explorer or Netscape's Navigator, which uses the HTTP protocol to communicate with a Web server 216 of the host site 201. The Web server 216 accesses a local catalog 220 (in the form of HTML or “Web” documents) which can be requested, retrieved and viewed by the customer via the Web browser 212. The catalog 220 include information generated by the host about the various products featured on the vendor Web site 206. This information may include prices, descriptions, reviews, and/or recommendations of the products that assist customers in making informed purchasing decisions. Generally, the catalog 220 is a database that is any type of data repository, including an SQL table or ASCII text file.

The catalog 220 served by the host site 201 may include hyperlinks to Web pages of the vendor Web sites 206 for allowing consumers to select products for prospective purchase. Typically, one such hyperlink is provided for each product displayed on the host Web site 201. Alternatively, a hyperlink may be provided for a group of products. When the customer selects (e.g., clicks on) the hyperlink associated with a particular product, the customer is automatically connected to the vendor Web site 206, and presented with various options (included within Web pages 236 served from the vendor Web site 106) for allowing the customer to purchase the selected product from the vendor. The hyperlink thus serves as a referral mechanism for referring the customer to the vendor Web site 206 from the host site 201.

Often, special hyperlinks (also referred to herein as “referral links”) of the host's catalog documents are provided in association with additional information (embedded in a predefined format within the associated URL) that is transmitted to the vendor Web site 206 in response to selection of the link. In one implementation, this information includes an identifier for the host and a unique identifier of the selected product (such as a SKU or UPC), as displayed in FIG. 2B.

In one implementation of the host Web site 201, selection of a referral link causes a product detail page 236 to be displayed on the customer computer 208. This detail page 236 is served by the vendor Web site 206, and includes various information provided by the vendor (price, inventory, standard product description, etc.) about the selected product. From this page, a hyperlink can be selected that allows the customer to purchase the item.

Because the identity of the customer is normally unknown to the host Web site 201, the site 201 uses cookies technology to identify the customer, so that the customer can be associated with previous purchases from the site 201. This process involves retrieving the cookie 240 from the customer computer 208 with the host server 216, and then executing a computer program 244 that compares the cookie against information stored in the customer data structure 260. If no information exists on the customer, or if no cookie exists on the customer computer 208, the customer data structure 260 is amended to include the customer. Any of a variety of alternative techniques can be used to identify the customer, including prompting the customer for a user ID, and/or using URL information returned by the customer's Web browser.

Although the embodiment described herein uses Web technology to disseminate the catalog documents 220, any of a variety of document types and electronic dissemination technologies can be used. For example, the associate's catalog documents may be in the form of hypertextual E-mail messages that are disseminated by a list server, or PUSH documents disseminated by a PUSH program 250. PUSH technology is an information dissemination technology used to send data to users over a network. In contrast to the World Wide Web (a “pull” technology), in which the client browser must request a Web page before it is sent, PUSH protocols send the informational content to the user computer automatically, typically based on information prespecified by the user. As interactive television, video-on-demand, and Web TV technologies continue to evolve, it is contemplated that the “catalog” will include video advertisements that are displayed to the customer on a television screen. Furthermore, although hypertextual catalog documents are preferably used, it is possible for the host site 201 to use non-hypertextual catalogs (including paper-based product catalogs) that simply instruct the customer to manually enter the appropriate URL (including the referral information) into a browser program.

In addition, although the system is described in the context of “the” host's Web site 201, it should be recognized that the host can disseminate catalog documents and accept the customer's orders from multiple different sites, including sites that use different document formats and transfer protocols. Further, although the system is described herein in the context of the vendor that sells products, it will be recognized that the architecture can also be used to sell services, including on-line services that are provided over the Internet.

As will be appreciated by those skilled in the art, the use of the URL-embedded information to identify the customer allows the customer to be identified and properly monitored with a high degree of reliability. For example, in contrast to conventional techniques, the present method allows the customer to be reliably identified even if the customer computer 208 operates behind a firewall. In addition, the method provides a high degree of flexibility to the host site 201. For example, the host can use or switch between multiple catalog dissemination techniques (Web, E-mail, PUSH, etc.).

A significant benefit of the system 200 is that it allows the task of marketing the vendor's products to be efficiently distributed to the host that has an established reputation and exposure within its own fields. For example, the assignee of the present invention, Deja.com Inc., has an existing client base and a reputation for collecting and providing on-line information.

The invention having been described, it will be apparent to those skilled in the art that the same may be varied in many ways without departing from the spirit and scope of the invention. Any and all such modifications are intended to be included within the scope of the following claims.

What is claimed is:

1. A method of incentivizing customers to place orders through a communication host server to purchase an item from an online vendor that is not associated with host server, the method comprising the steps of:
accepting and processing a purchase order from said customer through said host server, said order from said host server to said vendor sending; and
said site giving said customer a financial reward in a predetermined amount through said host server in consideration of said customer fulfilling at least one condition related to said purchase order.

2. The method of claim 1, wherein said reward is a discount on said purchase.

3. The method of claim 1, wherein said reward is a rebate paid to the customer after completion of said purchase.

4. The method of claim 1, wherein said reward is a discount on a future purchase from a future order placed through said site.

5. The method of claim 1, wherein said site receives a commission from said vendor and said predetermined amount is a percentage of the said commission.

6. The method of claim 1, wherein said predetermined amount is a percentage of a price for said item.

7. The method of claim 1, wherein said predetermined amount is fixed number.

8. The method of claim 1 further comprising the step of registering said customer.

9. The method of claim 8 wherein said step of registering said customer comprises:
collecting personal information from said customer, and
storing said biographical information.

10. The method of claim 8 further comprising the step of assigning an identifying code to the customer.

11. The method of claim 8, further comprising the step of storing a record of said purchase.

12. The method of claim 11, wherein the step of giving said customer a financial reward occurs only after said customer has made a prespecified number of purchases.

13. The method of claim 11, wherein the step of giving said customer a financial reward occurs only after said customer has spent a prespecified amount in purchases made through said site.

14. The method of claim 1, wherein the step of giving said customer a financial reward occurs only after said customer has participated in a predetermined activity on said site, other than placing said order.

15. The method of claim 1, wherein said item is related to art of entertainment.

16. A system for incentivizing customers to place orders through a communication host server to purchase an item from an online vendor that is not associated with said host server comprising:
order accepting means on said host server for accepting purchase orders from customers;
order processing means on said host server for processing said orders and the transmitting processed orders to said vendor; and
payment means on said host server to pay said customer a financial reward in a predetermined amount for satisfying at least one predetermined condition related to said order.

17. The system of claim 16 further comprising registration means on said host server to request and accept and store biographical information from said customer.

18. The system of claim 16 further comprising order storage means on said host server to store a record of said order.

19. The system of claim 16 further comprising reward administration means on said host server.
